(19) United States
(12) Patent Application Publication
(10) Pub. No.: US 2010/0241802 A1
(43) Pub. Date: Sep. 23, 2010

(54) STORAGE UNIT, DATA WRITE METHOD AND DATA WRITE PROGRAM

(75) Inventors: Atsushi IGASHIRA, Kawasaki (JP); Masanori Ito, Kawasaki (JP); Yoshihito Konta, Kawasaki (JP); Norihide Kubota, Kawasaki (JP); Kenji Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/696,219

(22) Filed: Jan. 29, 2010

(30) Foreign Application Priority Data
Mar. 19, 2009 (JP) 2009-67312

(51) Int. Cl. G06F 12/08; G06F 12/00

(52) U.S. Cl. 711/113; 711/E12.001; 711/E12.019

(57) ABSTRACT

A storage unit includes a cache memory, a cache controller which accesses the cache memory, one or more disk units, a data receiving unit, a merge interpolation determination unit, a data readout unit, a write data generation unit and a data write unit. The data receiving unit receives, from the cache controller, unit readout data that includes update records updated by the cache controller and is unit of data read from the cache memory. The merge interpolation determination unit determines whether the received unit readout data is merge interpolated. The data readout unit reads, from the disk unit, data corresponding to the unit readout data when the unit readout data is determined to be merge interpolated. The write data generation unit generates data to be written to the disk unit by merge interpolating the unit readout data. The data write unit writes, to the disk unit, the generated data.

### CROSS-REFERENCE TO RELATED APPLICATIONS

This application is based upon and claims the benefit of priority of the prior Japanese Patent Application No. 2009-67312, filed on Mar. 19, 2009, the entire contents of which are incorporated herein by reference.

### BACKGROUND

1. Field

Various embodiments described herein relate to a storage unit including a cache controller and a disk controller, a data write method for writing, to a disk unit, data that is updated by the cache controller, and a data write program.

2. Description of the Related Art

A storage playback unit may write, back to a record medium, data that is read from the record medium. For example, the following storage playback unit is proposed. In accordance with a signal that specifies editorial end point of video data, audio data or real time metadata corresponding to the video data or audio data on the record medium that is randomly accessible, writing, back to the record medium, data of record unit, in which the editorial end point is specified, is started after the period that corresponds to the record unit, in which the editorial end point is specified.

A storage unit including a cache memory and a disk unit may also write, back to the disk unit, update record that is updated on the cache memory. The storage unit may write, to the disk unit at discrete positions, a plurality of update records that are updated on the cache memory. In this case, it is necessary to write the update records to the disk unit separately by issuing write request for each update record. Consequently, load of the disk unit is increased.

### SUMMARY

A storage unit includes a cache memory, a cache controller, one or more disk units, a data receiving unit, a merge interpolation determination unit, a data readout unit, a write data generation unit and a data write unit. The cache controller accesses the cache memory. The data receiving unit receives, from the cache controller, unit readout data that includes update records updated by the cache controller and is unit of data read from the cache memory. The merge interpolation determination unit determines whether the received unit readout data is merge interpolated. The data readout unit reads, from the disk unit, data corresponding to the unit readout data when it is determined that the unit readout data is merge interpolated. The write data generation unit generates data to be written to the disk unit by merge interpolating the unit readout data based on the unit readout data and on data that is read from the disk unit. The data write unit writes, to the disk unit, the generated data to be written.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

### BRIEF DESCRIPTION OF THE DRAWINGS

FIG. 1 is a block diagram illustrating an example of a storage unit of an embodiment;

FIG. 2 is a block diagram illustrating an example of a RAID controller;

FIG. 3 is an illustration according to the storage unit of the embodiment, which illustrates process of writing update records to disk units;

FIG. 4 is a diagram for illustrating condition for merge interpolating unit readout data that is sent from a cache controller to the RAID controller;

FIG. 5 is a diagram for illustrating condition for merge interpolating unit readout data that is sent from a cache controller to the RAID controller;

FIG. 6 is a flow chart according to the storage unit of an embodiment, which illustrates an example of flow of process for writing update records to the disk unit; and

FIG. 7 is a diagram illustrating an example of operation for writing, back to a disk unit, update records that are updated in a cache memory.

### DETAILED DESCRIPTION OF THE EMBODIMENTS

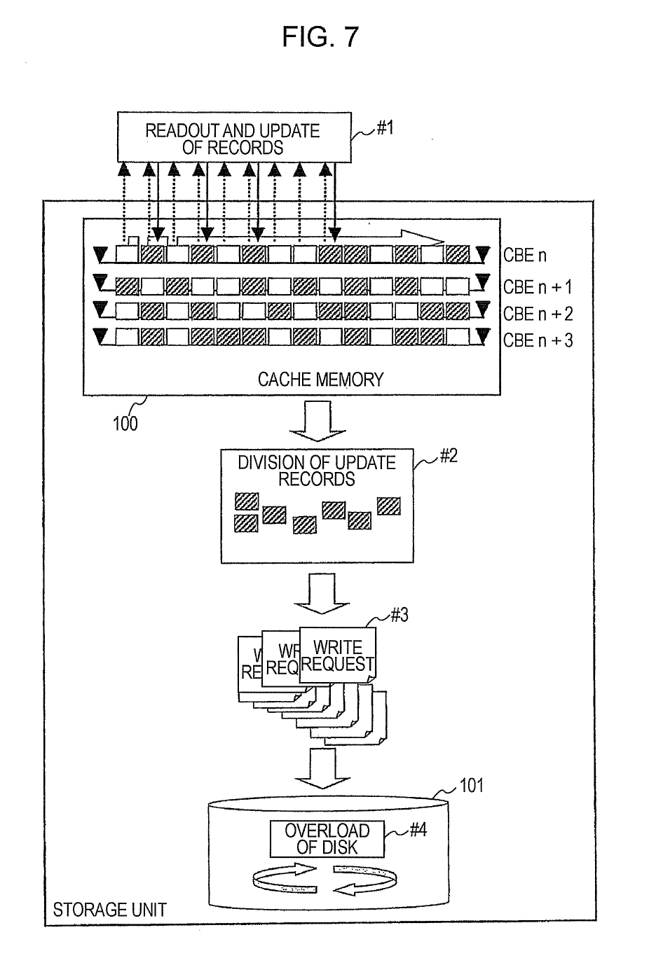

FIG. 7 relates to a storage unit including a cache memory and a disk unit, and is a diagram illustrating an example of operation for writing, back to the disk unit, the update records that are updated in the cache memory. The storage unit shown in FIG. 7 includes a cache controller (not shown) and a disk unit 101. The cache controller is a control unit that accesses a cache memory 100. The disk unit 101 includes a disk controller and a disk (not shown). A host computer (not shown) sequentially reads, for example, a small block of records of a form of DAM (Direct Access Memory) from the cache memory 100 and updates the records in the cache memory 100 (#1 of FIG. 7). The hatched areas of FIG. 7 indicate update records. When the records are updated, the update records may become discrete in CBE (Cache Block Entry) controlled by the cache memory 100. It is noted that unit CBE is one page of the cache memory 100.

For example, in a process of writing the update records back from the cache memory 100 to the disk unit, after dividing the above-described discrete update records into pieces (#2 of FIG. 7), the cache controller issues a write request of each update record to the disk controller (#3 of FIG. 7). The disk controller which accepts the write request writes each update record to the disk unit.

In the storage unit of FIG. 7, the disk controller writes each update record to the disk unit in compliance with update requests of the cache controller. Therefore, when the number of update records increases, the queue that issues the command sent to the disk unit 101 is increased, thereby causing overload of the disk unit (#4 of FIG. 7). Consequently, online processing of request to the disk unit for data readout is delayed.

The following will describe the storage unit of an embodiment, which enables reduction of load of disk units in writing update records back to the disk units.

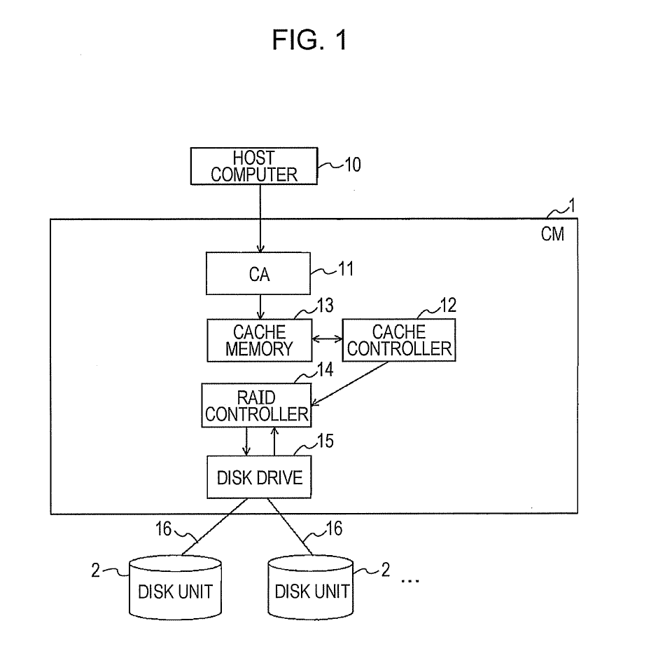

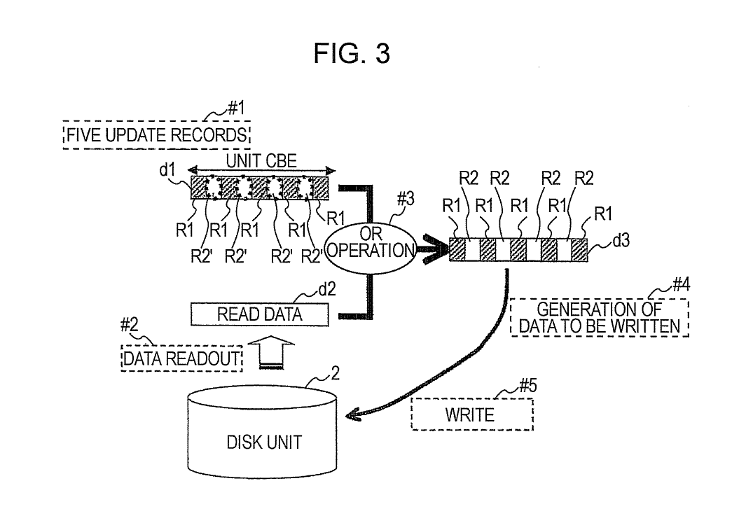

FIG. 1 is a block diagram illustrating an example of the storage unit of an embodiment. The storage unit of the embodiment includes a CM (Control Module) 1 and a plurality of disk units 2. The number of disk units 2 may be one. The storage unit is connected to a host computer 10. The CM 1 includes a CA (Channel Adapter) 11, a cache controller 12, a cache memory 13, a RAID (Redundant Arrays of Inexpensive Disks) controller 14 and a disk drive 15. The CM 1 writes data to the cache memory 13 in compliance with data write request from the host computer 10. In addition, the CM 1 reads data from the cache memory 13 in compliance with data readout request from the host computer 10. Further, the CM 1 writes update records back to the disk units 2. The update record means the record that is updated in the cache memory 13 by the cache controller 12. The update record will be described later with reference to FIG. 3. The disk unit 2 is a memory unit that stores data. For example, the disk unit 2 includes a physical disk.

The CA 11 mediates the communication between the CM 1 and the host computer 10. The cache controller 12 accepts data write request from the host computer 10 and writes data to the cache memory 13. That is, the cache controller 12 is a controller that accesses the cache memory 13. In addition, the cache controller 12 accepts data readout request from the host computer 10 and reads data from the cache memory 13. The cache controller 12 controls data written to the cache memory 13 by the CBE. The cache controller 12 sends unit readout data, track information and update record positional information to the RAID controller 14 when the record on the cache memory 13 is updated. The track information is information on track on the disk unit 2 in which data corresponding to the unit readout data is written. The update record positional information is positional information that indicates the position of the update record included in the unit readout data. The unit readout data includes one or more update records and is unit data that is read from the cache memory 13. The unit readout data is data of unit CBE, for example, and will be described later with reference to FIG. 3.

The cache memory 13 is a data storage unit, which can read and write data at higher speed than the disk unit 2. For example, the cache memory 13 is a semiconductor storage unit, or a storage unit that is accessible at higher speed than the disk unit 2. For example, the cache controller 12 copies data that is stored in the disk unit 2 and stores it in the cache memory 13. The RAID controller 14 is a disk controller that accesses the disk unit 2. The RAID controller 14 receives, from the cache controller 12, the unit readout data, which includes one or more update records updated on the cache memory 13 by the cache controller 12, and the track information on the disk unit 2, to which data corresponding to the unit readout data is written, and determines whether the unit readout data is merge interpolated. The merge interpolation means that when the update records included in the above-described unit readout data are discrete, that is, when any unupdated record is present between the update records in the unit readout data, the unupdated record in the unit readout data is interpolated by merging the data that corresponds to the unit readout data on the disk unit 2 and the unit readout data. The specific processing of the merge interpolation will be described later with reference to FIG. 3. The unupdated record means the record of the unit readout data to be processed which the cache controller 12 does not update on the cache memory 13.

When the RAID controller 14 determines that the unit readout data is merge interpolated, the RAID controller 14 reads data that corresponds to the unit readout data from the disk units 2 via the disk drive 15 and FC (Fiber Channel) 16. The RAID controller 14 merge interpolates the unit readout data based on the above-described unit readout data and data that is read out from the above-described disk units 2 to thereby generate data to be written to the disk units 2. The RAID controller 14 writes the above-described generated data to be written to the disk unit 2 via the disk drive 15 and the FC 16. When the RAID controller 14 determines that the unit readout data is not merge interpolated, the RAID controller 14 writes update records included in the unit readout data to the disk unit 2 separately. The disk drive 15 is connected to each disk unit 2 by the FC 16 which mediates data transfer between the disk drive 15 and the disk unit 2.

The functions of the storage unit and its various units of the present embodiment are implemented by the CPU and the program executed on the CPU. The program can be stored in a computer-readable recording medium such as semiconductor memory, hard disk, CD-ROM and DVD. The program is recorded and supplied on such a recording medium, or supplied by send and receive using network via communication interface.

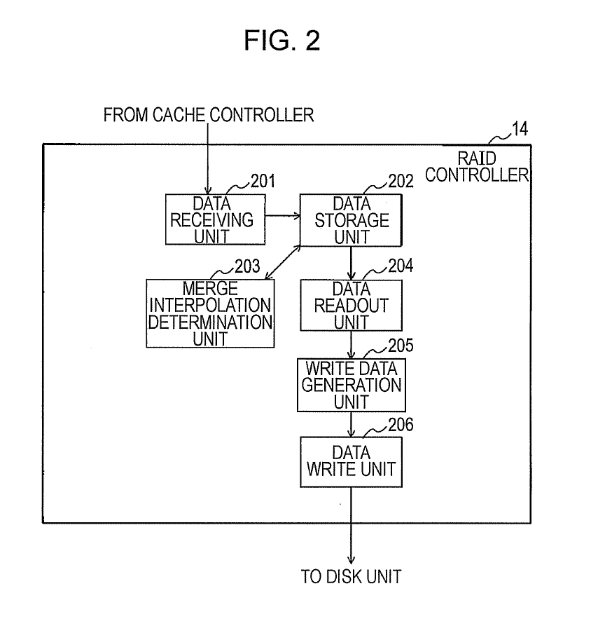

FIG. 2 is a block diagram illustrating an example of the RAID controller 14 of FIG. 1. The RAID controller 14 includes a data receiving unit 201, a data storage unit 202, a merge interpolation determination unit 203, a data readout unit 204, a write data generation unit 205 and a data write unit 206.

The data receiving unit 201 receives, from the cache controller 12, the unit readout data, which includes the update records updated by the cache controller 12, and sends it to the data storage unit 202. In addition, the data receiving unit 201 receives, from the cache controller 12, the track information on the disk units 2, to which data that corresponds to the above-described unit readout data is written, and sends it to the data storage unit 202. Further, the data receiving unit 201 receives the update record positional information on the unit readout data from the cache controller 12, and sends it to the data storage unit 202.

The data storage unit 202 receives and stores the unit readout data, the track information and the update record positional information sent by the data receiving unit 201. The merge interpolation determination unit 203 refers to the unit readout data stored by the data storage unit 202. The unit readout data is sent from the data storage unit 202 to the data readout unit 204. When the merge interpolation determination unit 203 notifies the data storage unit 202 that the unit readout data is merge interpolated, the track information stored by the data storage unit 202 is sent from the data storage unit 202 to the data readout unit 204. The merge interpolation determination unit 203 refers to the update record positional information stored by the data storage unit 202. The update record positional information is sent from the data storage unit 202 to the data readout unit 204. The merge interpolation determination unit 203 determines whether the unit readout data is merge interpolated based on the unit readout data, which is stored by the data readout unit 202, and on the update record positional information. The merge interpolation determination unit 203 determines whether the update records included in the unit readout data are discrete in the unit readout data and the number of discrete update records is equal to or more than a threshold. In the present embodiment, the threshold is three. It is noted that the threshold may be more than three. The above-described threshold can be empirically defined. The merge interpolation determination unit 203 notifies the data storage unit 202 that the unit readout data is merge interpolated when the merge interpolation determination unit 203 determines that the update records are discrete in the unit readout data and the number of discrete update records is equal to or more than a threshold.

It is noted that the merge interpolation determination unit 203 determines whether data traffic between the RAID controller 14 of the CM 1 and the disk units 2 is full. When the merge interpolation determination unit 203 determines that the data traffic is not full, the unit readout data may be merge interpolated. The state where the data traffic is full means that space of data transfer area of the FC 16 that connects the CM 1 and the disk unit 2 is not left When the data storage unit 202 is notified from the merge interpolation determination unit 203 that the unit readout data is merge interpolated, the data storage unit 202 sends the data readout unit 204 the track information that is sent from the data receiving unit 201 and stored, the unit readout data and the update record positional information.

The data readout unit 204 reads data that corresponds to the unit readout data from the disk unit 2 via the disk drive 15 and the FC 16 when the merge interpolation determination unit 203 determines that the unit readout data is merge interpolated. Specifically, the data readout unit 204 receives the track information and the unit readout data sent by the data storage unit 202, and reads the data corresponding to the unit readout data (corresponding data, hereinafter) from the disk unit 2 via the disk drive 15 and the FC 16 based on the received track information. The data readout unit 204 sends the unit readout data, the corresponding data, the update record positional information and the track information to the write data generation unit 205.

The write data generation unit 205 generates data to be written to the disk unit 2 by merge interpolating the unit readout data as shown in FIG. 3 based on the unit readout data, the corresponding data and the update record positional information which are sent from the data readout unit 204. This merge interpolation is indicated by OR operation in FIG. 3. The merge interpolation (OR operation) will be described as the following processing. The write data generation unit 205 applies the update records to update records included in the unit readout data. On the other hand, the write data generation unit 205 applies corresponding records to unupdated records included in the unit readout data. The corresponding records are records that are included in the corresponding data. The write data generation unit 205 merges the selected update records and the corresponding records. To be more specific, the write data generation unit 205 interpolates the unupdated records with the corresponding records by overwriting the unupdated records in the unit readout data with the corresponding records. Thus, data to be written to the disk unit 2 is generated. The write data generation unit 205 sends the data to be written and the track information to the data write unit 206.

The data write unit 206 receives the data to be written and record information, which are sent from the write data generation unit 205. The data write unit 206 writes data to be written, generated by the write data generation unit 205, to original part of the disk unit 2, to which the corresponding data read by the data readout unit 204 is written, via the disk drive 15 and the FC 16 based on the received record information. When the merge interpolation determination unit 203 determines that the unit readout data is not merge interpolated, the data write unit 206 writes the update records included in the unit readout data to the disk units 2 separately via the disk drive 15 and the FC 16.

FIG. 3 is an illustration according to the storage unit of the present embodiment, which illustrates process of writing the update records to the disk units. In FIG. 3, a unit readout data d1 is data of unit CBE. The hatched areas in FIG. 3 is update records R1. As shown in FIG. 3, five update records are present in the data d1 of unit CBE that is sent from the cache controller 12 (#1 of FIG. 3).

In the unit CBE, the dotted elliptical portions of FIG. 3 are unupdated records R2′. The data readout unit 204 reads the corresponding data d2 that corresponds to the data d1 of the unit CBE from the disk unit 2 via the disk drive 15 and the FC 16 (#2 of FIG. 3). The write data generation unit 205 merge interpolates based on the corresponding data d2 that is read from the disk unit 2 and on the data d1 of unit CBE (#3 of FIG. 3). Specifically, the write data generation unit 205 overwrites the unupdated records R2′ in the data d1 of unit CBE with the corresponding records R2 included in the corresponding data d2 that is read from the disk unit 2. Thus, the data d1 of unit CBE is merge interpolated by the corresponding data R2 that is read from the disk unit 2, thereby generating data d3 to be written (#4 of FIG. 3). The data write unit 206 writes the generated data d3 to be written to the disk unit 2 via the disk drive 15 and the FC 16 (#5 of FIG. 3). For example, the RAID controller 14 may write five update records included in unit CBE shown in FIG. 3 to the disk unit 2 separately. In this case, five write commands are issued from the RAID controller 14 to the disk unit 2.

However, the number of times for issuing command sent from the RAID controller 14 to the disk unit 2 becomes two, which is the sum of the one for issuing the data readout command and the one for issuing the data write command by merge interpolating the unit CBE and then writing it to the disk unit 2 collectively as in the present embodiment. Therefore, according to the storage unit of the present embodiment, the number of times for issuing command is reduced from five times to two times, so that load of the disk unit 2 is reduced.

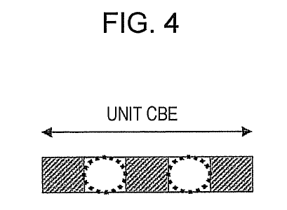

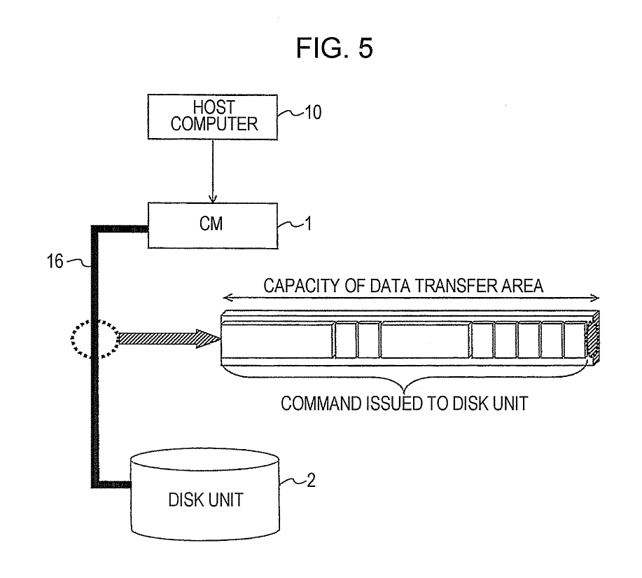

FIGS. 4 and 5 are diagrams for illustrating condition for merge interpolating unit readout data that is sent from the cache controller to the RAID controller. Referring to FIG. 4, the records of the hatched areas are update records. The RAID controller 14 determines that the unit CBE is merge interpolated, for example, when the number of discrete update records included in the unit CBE sent from the cache controller 12 is three or more and data traffic between the RAID controller 14 and the disk unit 2 is full.

As shown in FIG. 4, when the number of discrete update records included in the unit CBE is three, the number of times for issuing command required for writing is only two by merge interpolating the unit CBE and then writing it to the disk unit 2 collectively. Thus, the number of times for issuing command can be reduced by once as compared to the case where the three update records are written to the disk unit 2 separately.

As shown in FIG. 5, when data traffic between the RAID controller 14 of the CM 1 and the disk unit 2 is full, free space required for transferring merge interpolated data from the RAID controller 14 to the disk unit 2 is not left in data transfer area. This is a state where capacity of data transfer area of the FC 16 shown in FIG. 5 is filled with command issued to the disk unit 2. The RAID controller 14 merge interpolates the unit CBE updated by the cache controller 12 when the data traffic between the RAID controller 14 and the disk unit 2 is not full. When the data traffic between the RAID controller 14 and the disk unit 2 is full, the RAID controller 14 serves to write update records, which are included in the unit CBE updated by the cache controller 12, to the disk unit 2.

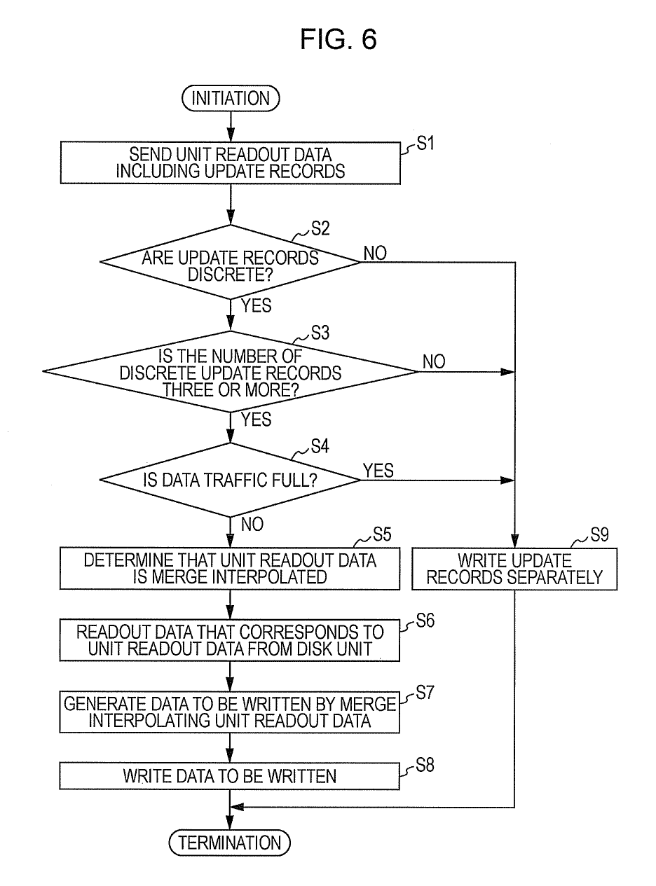

FIG. 6 is a flow chart according to the storage unit of the present embodiment, which illustrates an example of flow of process for writing update records to the disk unit.

The cache controller 12 sends the RAID controller 14 unit readout data including update records (step S1). Sending the unit readout data is performed when the cache controller 12 updates records on the cache memory 13. The merge interpolation determination unit 203 of the RAID controller 14 determines whether the update records are discrete in the unit readout data (step S2).

When the merge interpolation determination unit 203 determines that the update records are not discrete in the unit readout data (step S2, No), the data write unit 206 of the RAID controller 14 writes the update records separately to the disk unit 2 via the disk drive 15 and the FC 16 (step S9) and terminates the processing.

When the merge interpolation determination unit 203 determines that the update records are discrete in the unit readout data (step S2, Yes), the merge interpolation determination unit 203 determines whether the number of discrete update records is three or more (step S3). When the merge interpolation determination unit 203 determines that the number of discrete update records is not three or more (step S3, No), the step S3 proceeds to the step S9.

When the merge interpolation determination unit 203 determines that the number of discrete update records is three or more (step S3, Yes), the merge, interpolation determination unit 203 determines whether data traffic between the RAID controller 14 and the disk unit 2 is full (step S4). In the step S4, the merge interpolation determination unit 203 determines whether the data traffic is full based on whether the capacity of the data transfer area of the FC 16 that interconnects the CM 1 and the disk unit 2 is left. When the merge interpolation determination unit 203 determines that the data traffic between the RAID controller 14 and the disk unit 2 is full (step S4, Yes), the step S4 proceeds to the step S9.

When the merge interpolation determination unit 203 determines that the data traffic between the RAID controller 14 and the disk unit 2 is not full (step S4, No), the merge interpolation determination unit 203 determines that the unit readout data sent from the cache controller 12 is merge interpolated (step S5). Subsequently, the data readout unit 204 reads corresponding data that corresponds to the unit readout data from the disk unit 2 (step S6). The write data generation unit 205 merge interpolates unit readout data based on the unit readout data and on the corresponding data read from the disk unit 2, thereby generating data to be written to be disk unit 2 (step S7). The data write unit 206 writes the generated data to be written to the disk unit 2 via the disk drive 15 and the FC 16 (step S8) and terminates the processing.

According to the storage unit, when a plurality of update records that are updated on the cache memory are written back to the disk unit, the update records can be written back to the disk unit collectively by a predetermined unit without being written back to the disk unit separately. Therefore, according to the storage unit, when the update records that are updated on the cache memory are written back to the disk unit, overload of the disk unit is prevented.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage unit, comprising:
a cache memory;
a cache controller configured to access the cache memory;
at least one disk unit;
a data receiving unit configured to receive, from the cache controller, unit readout data that includes update records updated by the cache controller and that is unit of data read from the cache memory;
a merge interpolation determination unit configured to determined whether the received unit readout data is merge interpolated;
a data readout unit configured to read, from the at least one disk unit, data corresponding to the unit readout data when it is determined that the unit readout data is merge interpolated;
a write data generation unit configured to generate data to be written to the at least one disk unit by merge interpolating the unit readout data based on the unit readout data and on data that is read from the at least one disk unit; and
a data write unit configured to write, to the at least one disk unit, the generated data to be written.

2. The storage unit according to claim 1, wherein
the merge interpolation determination unit determines whether the update records included in the unit readout data are discrete and whether the number of the discrete update records is three or more, and
when the merge interpolation determination unit determines that the update records are discrete in the unit readout data and the number of the discrete update records is three or more, the merge interpolation determination unit determines that the unit readout data is merge interpolated.

3. The storage unit according to claim 2, wherein
the merge interpolation determination unit further determines whether data traffic between the disk controller and the at least one disk unit is full, and
when the merge interpolation determination unit determines that the data traffic is full, the merge interpolation determination unit determines that the unit readout data is merge interpolated.

4. A data write method in a storage unit that includes a cache memory, a cache controller for accessing the cache memory, at least one disk unit, a disk controller for accessing the at least one disk unit, and for writing, to the at least one disk unit, update records updated by the cache controller, the data write method comprising:
receiving, by the disk controller from the cache controller, unit readout data that includes update records updated by the cache controller and is unit of data read from the cache memory;
determining, by the disk controller, whether the received unit readout data is merge interpolated;
reading, by the disk controller from the at least one disk unit, data corresponding to the unit readout data when the disk controller determines that the unit readout data is merge interpolated;
generating, by the disk controller, data to be written to the at least one disk unit by merge interpolating the unit readout data based on the unit readout data and on data that is read from the at least one disk unit; and
writing, by the disk controller to the at least one disk unit, the generated data to be written collectively.

5. The data write method according to claim 4, further comprising:
determining, by the disk controller, whether the update records included in the unit readout data are discrete and whether the number of the discrete update records is three or more; and
determining, by the disk controller, that the unit readout data is merge interpolated when the disk controller determines that the update records are discrete in the unit readout data and the number of the discrete update records is three or more.

6. The data write method according to claim 4, further comprising:
determining, by the disk controller, whether data traffic between the disk controller and the disk units is full; and
determining, by the disk controller, that the unit readout data is merge interpolated when the disk controller determines that the data traffic is full.

7. A computer-readable recording medium encoded with a storage unit that includes a cache memory, a cache controller for accessing the cache memory, at least one disk unit and a disk controller for accessing the at least one disk unit, a program for writing to the at least one disk unit update records updated by the cache controller, containing instructions executable on a computer, the program causing the computer as the disk controller to execute:
receiving, from the cache controller, unit readout data that includes update records updated by the cache controller and is unit of data read from the cache memory;
determining whether the received unit readout data is merge interpolated;
reading, from the at least one disk unit, data corresponding to the unit readout data when the disk controller determines that the unit readout data is merge interpolated;
generating data to be written to the at least one disk unit by merge interpolating the unit readout data based on the unit readout data and on the data that is read from the at least one disk unit; and
writing, to the at least one disk unit, the generated data to be written collectively.
